(19) United States
(12) Patent Application Publication
(10) Pub. No.: US 2005/0060269 A1
(43) Pub. Date: Mar. 17, 2005

(54) Method and system for gift delivery

(76) Inventor: Joseph Gaikoski, Plano, TX (US)

Correspondence Address: W. Thomas Timmons;The White House on Turtle Creek, 2401 Turtle Creek Blvd, Dallas, TX, 75219-4760, US

(21) Appl. No.: 10/661,143

(22) Filed: Sep. 12, 2003

(51) Int. Cl. G06F 17/60

(52) U.S. Cl. 705/400

(57) ABSTRACT

A method for delivering gifts of predetermined size and maximum weight, according to the present invention, includes the steps of selecting delivery boxes, each box selected of the proper size for a gift of the predetermined size; providing means for placing a proper delivery name and address on each box; affixing delivery indicia on each box of the proper denomination for the maximum weight plus the weight of the box for a given carrier; placing a purchased gift into a box of the proper size and having the indicia for the proper denomination; closing the box; placing a proper delivery name and address on the box using the means for placing a proper delivery name and address; and delivering the closed box to the given carrier. A system, according to the present invention, for delivering gifts of predetermined size and maximum weight, includes selected delivery boxes, each box selected of the proper size for a gift of the predetermined size; means for placing a proper delivery name and address on each box; delivery indicia on each box of the proper denomination for the maximum weight plus the weight of the box for a given carrier; wherein a purchased gift is placed into a box of the proper size and having the indicia for the proper denomination, and the box is then closed. A proper delivery name and address is placed on the box using the means for placing a proper delivery name and address and the closed box is delivered to the given carrier. Both the method and the system work for CD jewel cases and DVD cases which hold one or two disks, as well as for other standard size gifts.

### BACKGROUND OF THE INVENTION

1. Field of the Invention

The present invention relates generally to the purchase and delivery of standard size gifts directly from the store where the gift is purchased or from a central location such as a post office.

2. Description of Related Art

Mailing boxes exist for mailing compact disks. These boxes work for standard size CD jewel cases with either one or two disks. Envelopes can be bought with minimum postage already affixed for mailing simple letters.

### SUMMARY OF THE INVENTION

A method for delivering gifts of predetermined size and maximum weight, according to the present invention, includes the steps of selecting delivery boxes, each box selected of the proper size for a gift of the predetermined size; providing means for placing a proper delivery name and address on each box; affixing delivery indicia on each box of the proper denomination for the maximum weight plus the weight of the box for a given carrier; placing a purchased gift into a box of the proper size and having the indicia for the proper denomination; closing the box; placing a proper delivery name and address on the box using the means for placing a proper delivery name and address; and delivering the closed box to the given carrier.

In one method according to the present invention, the gifts are compact disks in jewel cases. Some of the jewel cases contain one compact disk and some jewel cases contain two compact disks, so that they are the same size, but of different weights. In an embodiment where the given carrier is a postal carrier, the indicia is a postal indicia, and the proper denomination is the postage for a jewel case with two compact disks and a box.

In another embodiment, a method according to the present invention, the gifts are digital video disks (DVD's), each in a particular digital video disk case of a given size, some cases containing one digital video disk and some cases containing two digital video disks. In embodiments wherein the given carrier is a postal carrier, the indicia is a postal indicia, and the proper denomination is the postage for a case with two digital video disks and a box.

In a method according to the present invention, wherein the given carrier is a freight carrier, the indicia is applied to a waybill for the freight carrier, which is affixed to the box, and the proper denomination is the indicator for package weight.

In a method according to the present invention, wherein the given carrier is a ship carrier, the indicia is applied to a waybill for the ship carrier, which is affixed to the box, and the proper denomination is the indicator for package weight.

A method according to the present invention, can also include the step of providing a gift card which for enclosing in or attaching to the box.

A system, according to the present invention, for delivering gifts of predetermined size and maximum weight, includes selected delivery boxes, each box selected of the proper size for a gift of the predetermined size; means for placing a proper delivery name and address on each box; delivery indicia on each box of the proper denomination for the maximum weight plus the weight of the box for a given carrier; wherein a purchased gift is placed into a box of the proper size and having the indicia for the proper denomination, and the box is then closed. A proper delivery name and address is placed on the box using the means for placing a proper delivery name and address and the closed box is delivered to the given carrier.

A system according to The present invention, wherein the gifts are compact disks in jewel cases, some jewel cases containing one compact disk and some jewel cases containing two compact disks, and wherein the given carrier is a postal carrier, and wherein the indicia is a postal indicia, and the proper denomination is the postage for a jewel case with two compact disks and a box.

In one system according to the present invention, the gifts are digital video disks, each in a particular digital video disk case of a given size. Some cases contain one digital video disk and some cases containing two digital video disks. The given carrier is a postal carrier, and the indicia is a postal indicia, and the proper denomination is the postage for a case with two digital video disks and a box.

In one system according to the present invention, the given carrier is a freight carrier, and the indicia is applied to a waybill for the freight carrier, which is affixed to the box. The proper denomination is the indicator for package weight.

In another system according to the present invention, the given carrier is a ship carrier, and the indicia is applied to a waybill for the ship carrier, which is affixed to the box. Once again, the proper denomination is the indicator for package weight.

A gift card can be enclosed in or attached to the box.

These and other objects, advantages and features of this invention will be apparent from the following description taken with reference to the accompanying drawing, wherein is shown a preferred embodiment of the invention.

### BRIEF DESCRIPTION OF THE DRAWING

FIG. 1 is a pictorial representation of a system according to the present invention;

FIG. 2 is a pictorial representation of an alternative embodiment to part of a system according to the present invention; and

FIG. 3 is a block diagram representation of a method according to the present invention.

### DESCRIPTION OF THE PREFERRED EMBODIMENTS

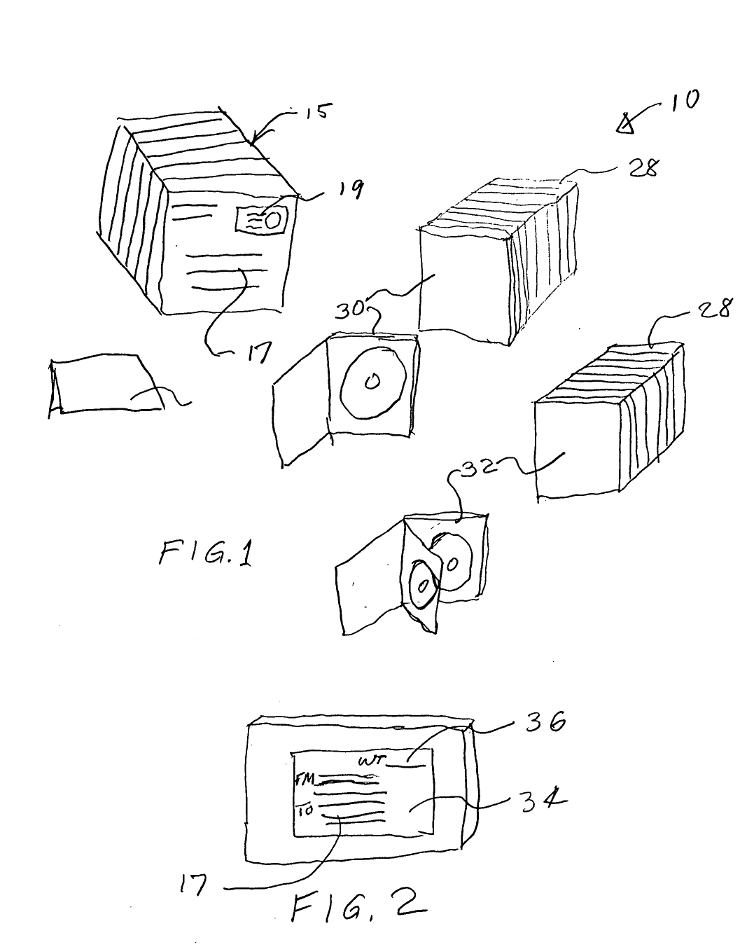

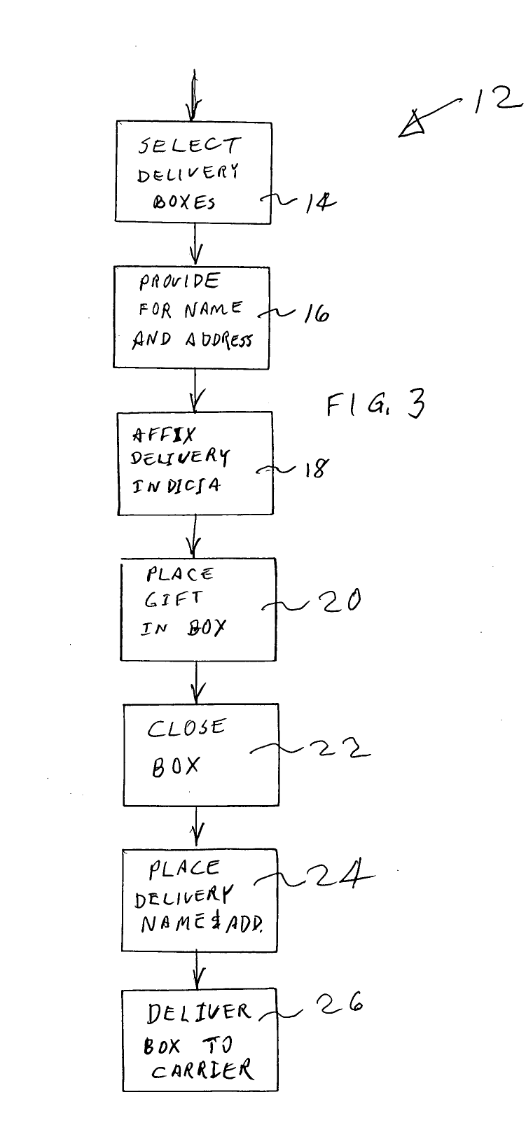

Referring now to the figures, and in particular to FIG. 1 and FIG. 3, a system for delivering gifts of predetermined size and maximum weight, according to the present invention, is referred to generally by reference numeral 10 and a method is referred to generally by reference numeral 12. Method 12 includes the steps of selecting 14 delivery boxes 15, each box selected of the proper size for a gift of the predetermined size; providing 16 means 17 for placing a proper delivery name and address on each box; affixing 18 delivery indicia 19 on each box of the proper denomination for the maximum weight plus the weight of the box for a given carrier; placing 20 a purchased gift into a box of the proper size and having the indicia for the proper denomination; closing 22 the box; placing 24 a proper delivery name and address on the box using the means for placing a proper delivery name and address; and delivering 26 the closed box to the given carrier. Indicia can be applied directly to the box, but it can also be in the form of a stamp or stamps or label or other form affixed to the box.

In one method according to the present invention, the gifts are compact disks (CD's) in jewel cases 28. Some of the jewel cases 30 contain one compact disk and some jewel cases 32 contain two compact disks, so that they are the same size, but of different weights. In an embodiment where the given carrier is a postal carrier, the indicia is a postal indicia, and the proper denomination is the postage for a jewel case with two compact disks and a box.

In another embodiment, a method according to the present invention, the gifts are digital video disks (DVD's), each in a particular digital video disk case of a given size, some cases containing one digital video disk and some cases containing two digital video disks. Pictorially, this is the same as FIG. 1. In embodiments wherein the given carrier is a postal carrier, the indicia is a postal indicia, and the proper denomination is the postage for a case with two digital video disks and a box.

Referring also to FIG. 2, in a method according to the present invention, wherein the given carrier is a freight carrier, the indicia is applied to a waybill 34 for the freight carrier, which is affixed to the box, and the proper denomination is the indicator 36 for package weight.

In a method according to the present invention, wherein the given carrier is a ship carrier, the indicia is applied to a waybill for the ship carrier, which is affixed to the box, and the proper denomination is the indicator for package weight.

A method according to the present invention, can also include the step of providing a gift card 38 which for enclosing in or attaching to the box.

System 10, according to the present invention, for delivering gifts of predetermined size and maximum weight, includes selected delivery boxes 15, each box selected of the proper size for a gift 28 of the predetermined size; means 17 for placing a proper delivery name and address on each box; delivery indicia 19 on each box of the proper denomination for the maximum weight plus the weight of the box for a given carrier; wherein a purchased gift is placed into a box of the proper size and having the indicia for the proper denomination, and the box is then closed. A proper delivery name and address is placed on the box using the means for placing a proper delivery name and address and the closed box is delivered to the given carrier.

A system according to The present invention, wherein the gifts are compact disks in jewel cases 28, some jewel cases 30 containing one compact disk and some jewel cases 32 containing two compact disks, and wherein the given carrier is a postal carrier, and wherein the indicia is a postal indicia, and the proper denomination is the postage for a jewel case with two compact disks and a box.

In one system according to the present invention, the gifts are digital video disks, each in a particular digital video disk case of a given size. Some cases contain one digital video disk and some cases containing two digital video disks. Pictorially, this is the same as FIG. 1. The given carrier is a postal carrier, and the indicia is a postal indicia, and the proper denomination is the postage for a case with two digital video disks and a box.

In one system according to the present invention, the given carrier is a freight carrier, and the indicia is applied to a waybill for the freight carrier, which is affixed to the box. The proper denomination is the indicator for package weight.

In another system according to the present invention, the given carrier is a ship carrier, and the indicia is applied to a waybill for the ship carrier, which is affixed to the box. Once again, the proper denomination is the indicator for package weight.

A gift card 38 can be enclosed in or attached to the box.

It can now be seen that the present system and method can be used by stores which sell gift items such as compact disks and digital video disks. A customer purchases a gift item and for a small additional fee can purchase a “delivery package” which is complete with postage or other shipping indicia and a gift card. The customer can complete the address or have it printed by the store, sign the card and it is ready to go. The customer then simply gives it to the store clerk who puts it in an “out” bin for shipment. It requires minimum time for the store clerk and greatly reduces the chance for human error.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A method for delivering gifts of predetermined size and no more than a maximum weight, comprising, in combination, the steps of:
selecting delivery boxes, each box selected of the proper size for a gift of the predetermined size;
providing means for placing a proper delivery name and address on each box;
affixing delivery indicia on each box of the proper denomination for the maximum weight plus the weight of the box for a given carrier;
placing a purchased gift into a box of the proper size and having the indicia for the proper denomination;
closing the box;
placing a proper delivery name and address on the box using the means for placing a proper delivery name and address; and
delivering the closed box to the given carrier.

2. A method according to claim 1, wherein the gifts are compact disks in jewel cases, some jewel cases containing one compact disk and some jewel cases containing two compact disks, and wherein the given carrier is a postal carrier, and wherein the indicia is a postal indicia, and the proper denomination is the postage for a jewel case with two compact disks and a box.

3. A method according to claim 1, wherein the gifts are digital video disks, each in a particular digital video disk case of a given size, some cases containing one digital video disk and some cases containing two digital video disks, and wherein the given carrier is a postal carrier, and wherein the indicia is a postal indicia, and the proper denomination is the postage for a case with two digital video disks and a box.

4. A method according to claim 1, wherein the given carrier is a freight carrier, and wherein the indicia is applied to a waybill for the freight carrier, which is affixed to the box, and the proper denomination is the indicator for package weight.

5. A method according to claim 1, wherein the given carrier is a ship carrier, and wherein the indicia is applied to a waybill for the ship carrier, which is affixed to the box, and the proper denomination is the indicator for package weight.

6. A method according to claim 1, further comprising the step of providing a gift card for enclosing in or attaching to the box.

7. A system for delivering gifts of predetermined size and no more than a maximum weight, comprising in combination:
selected delivery boxes, each box selected of the proper size for a gift of the predetermined size;
means for placing a proper delivery name and address on each box;
delivery indicia on each box of the proper denomination for the maximum weight plus the weight of the box for a given carrier;
wherein a purchased gift is placed into a box of the proper size and having the indicia for the proper denomination, and the box is then closed;
and wherein a proper delivery name and address is placed on the box using the means for placing a proper delivery name and address; and
wherein the closed box is delivered to the given carrier.

8. A system according to claim 7, wherein the gifts are compact disks in jewel cases, some jewel cases containing one compact disk and some jewel cases containing two compact disks, and wherein the given carrier is a postal carrier, and wherein the indicia is a postal indicia, and the proper denomination is the postage for a jewel case with two compact disks and a box.

9. A system according to claim 7, wherein the gifts are digital video disks, each in a particular digital video disk case of a given size, some cases containing one digital video disk and some cases containing two digital video disks, and wherein the given carrier is a postal carrier, and wherein the indicia is a postal indicia, and the proper denomination is the postage for a case with two digital video disks and a box.

10. A system according to claim 7, wherein the given carrier is a freight carrier, and wherein the indicia is applied to a waybill for the freight carrier, which is affixed to the box, and the proper denomination is the indicator for package weight.

11. A system according to claim 7, wherein the given carrier is a ship carrier, and wherein the indicia is applied to a waybill for the ship carrier, which is affixed to the box, and the proper denomination is the indicator for package weight.

12. A system according to claim 7, further comprising a gift card which can be enclosed in or attached to the box.

13. A method for delivering items of predetermined size and no more than a maximum weight, comprising, in combination, the steps of:
selecting delivery boxes, each box selected of the proper size for an item of the predetermined size;
providing means for placing a proper delivery name and address on each box;
affixing delivery indicia on each box of the proper denomination for the maximum weight plus the weight of the box for a given carrier;
placing an item into a box of the proper size and having the indicia for the proper denomination;
closing the box;
placing a proper delivery name and address on the box using the means for placing a proper delivery name and address; and
delivering the closed box to the given carrier.

14. A method according to claim 13, wherein the items are compact disks in jewel cases, some jewel cases containing one compact disk and some jewel cases containing two compact disks, and wherein the given carrier is a postal carrier, and wherein the indicia is a postal indicia, and the proper denomination is the postage for a jewel case with two compact disks and a box.

15. A method according to claim 13, wherein the items are digital video disks, each in a particular digital video disk case of a given size, some cases containing one digital video disk and some cases containing two digital video disks, and wherein the given carrier is a postal carrier, and wherein the indicia is a postal indicia, and the proper denomination is the postage for a case with two digital video disks and a box.

16. A method according to claim 13, wherein the given carrier is a freight carrier, and wherein the indicia is applied to a waybill for the freight carrier, which is affixed to the box, and the proper denomination is the indicator for package weight.

17. A method according to claim 13, wherein the given carrier is a ship carrier, and wherein the indicia is applied to a waybill for the ship carrier, which is affixed to the box, and the proper denomination is the indicator for package weight.

18. A method according to claim 13, further comprising the step of providing a card for enclosing in or attaching to the box.

19. A system for delivering items of predetermined size and no more than a maximum weight, comprising in combination:
selected delivery boxes, each box selected of the proper size for an item of the predetermined size;
means for placing a proper delivery name and address on each box;
delivery indicia on each box of the proper denomination for the maximum weight plus the weight of the box for a given carrier;
wherein an item is placed into a box of the proper size and having the indicia for the proper denomination, and the box is then closed;
and wherein a proper delivery name and address is placed on the box using the means for placing a proper delivery name and address; and
wherein the closed box is delivered to the given carrier.

20. A system according to claim 19, wherein the items are compact disks in jewel cases, some jewel cases containing one compact disk and some jewel cases containing two compact disks, and wherein the given carrier is a postal carrier, and wherein the indicia is a postal indicia, and the proper denomination is the postage for a jewel case with two compact disks and a box.

21. A system according to claim 19, wherein the items are digital video disks, each in a particular digital video disk case of a given size, some cases containing one digital video disk and some cases containing two digital video disks, and wherein the given carrier is a postal carrier, and wherein the indicia is a postal indicia, and the proper denomination is the postage for a case with two digital video disks and a box.

22. A system according to claim 19, wherein the given carrier is a freight carrier, and wherein the indicia is applied to a waybill for the freight carrier, which is affixed to the box, and the proper denomination is the indicator for package weight.

23. A system according to claim 19, wherein the given carrier is a ship carrier, and wherein the indicia is applied to a waybill for the ship carrier, which is affixed to the box, and the proper denomination is the indicator for package weight.

24. A system according to claim 19, further comprising a card which can be enclosed in or attached to the box.

25. A method for delivering disks in cases of predetermined size and no more than a maximum weight, comprising, in combination, the steps of:
selecting delivery boxes, each box selected of the proper size for a case of the predetermined size;
providing means for placing a proper delivery name and address on each box;
affixing delivery indicia on each box of the proper denomination for the maximum weight plus the weight of the box for a given carrier;
placing a case into a box of the proper size and having the indicia for the proper denomination;
closing the box;
placing a proper delivery name and address on the box using the means for placing a proper delivery name and address; and
delivering the closed box to the given carrier.

26. A method according to claim 25, wherein the disks in cases are compact disks in jewel cases, some jewel cases containing one compact disk and some jewel cases containing two compact disks, and wherein the given carrier is a postal carrier, and wherein the indicia is a postal indicia, and the proper denomination is the postage for a jewel case with two compact disks and a box.

27. A method according to claim 25, wherein the disks in cases are digital video disks, each in a particular digital video disk case of a given size, some cases containing one digital video disk and some cases containing two digital video disks, and wherein the given carrier is a postal carrier, and wherein the indicia is a postal indicia, and the proper denomination is the postage for a case with two digital video disks and a box.

28. A method according to claim 25, wherein the given carrier is a freight carrier, and wherein the indicia is applied to a waybill for the freight carrier, which is affixed to the box, and the proper denomination is the indicator for package weight.

29. A method according to claim 25, wherein the given carrier is a ship carrier, and wherein the indicia is applied to a waybill for the ship carrier, which is affixed to the box, and the proper denomination is the indicator for package weight.

30. A method according to claim 25, further comprising the step of providing a card for enclosing in or attaching to the box.

31. A system for delivering disks in cases of predetermined size and no more than a maximum weight, comprising in combination:
selected delivery boxes, each box selected of the proper size for a disk of the predetermined size;
means for placing a proper delivery name and address on each box;
delivery indicia on each box of the proper denomination for the maximum weight plus the weight of the box for a given carrier;
wherein a case is placed into a box of the proper size and having the indicia for the proper denomination, and the box is then closed;
and wherein a proper delivery name and address is placed on the box using the means for placing a proper delivery name and address; and
wherein the closed box is delivered to the given carrier.

32. A system according to claim 31, wherein the disks in cases are compact disks in jewel cases, some jewel cases containing one compact disk and some jewel cases containing two compact disks, and wherein the given carrier is a postal carrier, and wherein the indicia is a postal indicia, and the proper denomination is the postage for a jewel case with two compact disks and a box.

33. A system according to claim 31, wherein the disks in cases are digital video disks, each in a particular digital video disk case of a given size, some cases containing one digital video disk and some cases containing two digital video disks, and wherein the given carrier is a postal carrier, and wherein the indicia is a postal indicia, and the proper denomination is the postage for a case with two digital video disks and a box.

34. A system according to claim 31, wherein the given carrier is a freight carrier, and wherein the indicia is applied to a waybill for the freight carrier, which is affixed to the box, and the proper denomination is the indicator for package weight.

35. A system according to claim 31, wherein the given carrier is a ship carrier, and wherein the indicia is applied to a waybill for the ship carrier, which is affixed to the box, and the proper denomination is the indicator for package weight.

36. A system according to claim 31, further comprising a card which can be enclosed in or attached to the box.

37. A delivery box for a gift of predetermined size and no more than a maximum weight, comprising, in combination:
means for placing a proper delivery name and address on each box; and
delivery indicia on the box of the proper denomination for the maximum weight plus the weight of the box for a given carrier, wherein the box is of the proper size for the gift of the predetermined size to be placed into the box.

38. A delivery box for an item of predetermined size and no more than a maximum weight, comprising, in combination:
means for placing a proper delivery name and address on each box; and
delivery indicia on the box of the proper denomination for the maximum weight plus the weight of the box for a given carrier, wherein the box is of the proper size for the item of the predetermined size to be placed into the box.

39. A delivery box for one or more disks in a case of predetermined size and no more than a maximum weight, comprising, in combination:
means for placing a proper delivery name and address on each box; and
delivery indicia on the box of the proper denomination for the maximum weight plus the weight of the box for a given carrier, wherein the box is of the proper size for the case of the predetermined size to be placed into the box.
